(19) United States
(12) Patent Application Publication
(10) Pub. No.: US 2020/0001459 A1
(43) Pub. Date: Jan. 2, 2020

(54) ROBOT SYSTEM AND CONTROL METHOD OF THE SAME

(71) Applicant: LG ELECTRONICS INC., Seoul (KR)

(72) Inventor: Joonkeol Song, Seoul (KR)

(73) Assignee: LG ELECTRONICS INC., Seoul (KR)

(21) Appl. No.: 16/566,590

(22) Filed: Sep. 10, 2019

(30) Foreign Application Priority Data
Aug. 20, 2019 (KR) 10-2019-0101563

(51) Int. Cl. B25J 9/16; B25J 13/08; B25J 13/00; A63B 23/035

(52) U.S. Cl. CPC B25J 9/1669; B25J 9/161; B25J 9/1682; A63B 23/03541; B25J 13/003; B25J 13/081; B25J 13/085

(57) ABSTRACT

The present embodiment includes a left exercise module and a right exercise module which are horizontally spaced apart from each other and each of which includes: a lifting guide; a carrier lifted/lowered and guided along the lifting guide; and a robot arm installed on the carrier, including an end effector connected to an arm; and having a height changed by the carrier.

### CROSS-REFERENCE TO RELATED APPLICATIONS

This application claims the benefit of priority to Korean Patent Application No. 10-2019-0101563, filed in the Korean Intellectual Property Office on Aug. 20, 2019, the entire contents of which are incorporated herein by reference.

### BACKGROUND

The present disclosure relates to a robot system and a control method of the same.

Robots are machines that automatically process given tasks or operate with their own capabilities. The application fields of robots are generally classified into industrial robots, medical robots, aerospace robots, and underwater robots. Recently, communication robots that can communicate with humans by voices or gestures have been increasing.

Recently, technology for performing an exercise using a robot tends to increase, and an example of such technology is disclosed in Korean Registered Patent Publication No. 10-1806798 (published on Dec. 11, 2017) as a one-to-one moving action-type smart sparring device using a moving action-type sparring robot module including an exercise force-specified algorithm engine unit.

The smart sparring device is constituted by: a motion detection sensor module which is positioned on a glove of an object to spar with and generates a motion signal corresponding to the movement of the object; and a moving action-type sparring robot module which receives the motion signal generated by the motion detection sensor module, and measures the momentum of the object to spar with while controlling avoidance of strike to arms and the body, wherein the moving action-type sparring robot module includes a sparring exercise body formed in a half-body shape including a face, arms and a trunk and supported and protected from external pressure of each constituent elements.

### SUMMARY

The smart sparring device using a robot according to conventional arts has a merit of being suitable for a single exercise of boxing training, but is not easy to assist various kinds of exercise, and has low applicability.

The purpose of the present invention is to provide a robot system which is capable of assisting various exercises by means of a pair of robot arms and has high applicability and a method for controlling the same.

Another purpose of the present invention is to provide a robot system, which assists each of multiple users having mutually different body sizes such as heights in performing an efficient exercise, and a method for controlling the same.

A robot system according to an embodiment of the present invention includes a left exercise module and a right exercise module which are horizontally spaced apart from each other.

Each of the left exercise module and the right exercise module may include a lifting guide and a carrier lifted/lowered and guided along the lifting guide, and a robot arm having an end effector connected to an arm and having a height changed by the carrier.

A maximum length of the robot arm may be shorter than the length of the lifting guide.

The maximum length of the robot arm may be shorter than the distance between the lifting guide of the left exercise module and the lifting guide of the right exercise module.

The robot system may further include a controller that controls the robot arms. The controller may control the robot arms in a plurality of modes. The plurality of modes may include a waiting mode in which the robot arms are moved to a waiting position, and an exercise mode in which the robot arms are moved to an exercise region where the robot arms are operable by a user.

A first distance between the robot arm of the left exercise module and the robot arm of the right exercise module in the waiting mode may be larger than a second distance between the robot arm of the left exercise module and the robot arm of the right exercise module in the exercise mode.

The robot system may further include lifting mechanisms that raise/lower the respective carriers.

The lifting mechanisms may raise/lower the carrier of the left exercise module and the carrier of the right exercise module to the same height

Each of the left exercise module and the right exercise module may further include a carrier locker that fixes the carrier.

The robot system may include an input unit for a user input. The input unit may be arranged on the carrier.

The robot system may include a speaker that provides a user with voice guidance. The speaker unit may be arranged on the carrier.

The robot system may further include torque sensors that sense torque of the arms and angles of the arms.

The robot arms may each further include an end effector sensor installed on the end effector.

The end effector sensors may each further include a touch sensor that senses a touch of the user. The end effector sensors may each further include a force sensor that senses a force applied to the end effector.

A method for controlling a robot system may control a robot system including carriers in which a left exercise module and a right exercise module each lifted/lower and guided along a lifting guide, and robot arms each having a height changed by the carrier

In accordance with an embodiment, a method for controlling a robot system includes: a capturing step for capturing the body of a user by a vision sensor when user information is input by a user; a storing step for storing user data according to the body of the user in a memory; a movement step for calculating an exercise motion determined by the user data and exercise information when desired exercise information is input by the user and moving end effectors to an exercise region when the user is located at the exercise region; and a motion step for performing the exercise motion by robot arms R when the user holds the end effectors.

In the movement step, whether the user is located at the exercise region may be determined by an image captured by the vision sensor.

The method for controlling the robot system may further include an inquiring step for inquiring the user of the suitability of the present exercise motion via the output unit.

After the inquiring step, when the user inputs satisfaction via the input unit, a storing step for storing in a memory whether the exercise motion succeeds for each user may be performed.

In the method for controlling the robot system, after the inquiring step, when the user inputs dissatisfaction via the input unit, a correction step for generating a new exercise motion. In accordance with another embodiment, method for controlling a robot system includes: a display steps for displaying on an output unit an exercise motion corresponding to exercise information when a user inputs the exercise information; a movement step in which when the user inputs agreement to the displayed exercise motion, end effectors of the robot arms are moved to an exercise region; and a motion step in which when the user holds the end effectors, the robot arms perform an exercise motion determined according to the input exercise information.

The exercise information input by the user may include an exercise strength, and in the motion step, a torque corresponding to the exercise strength may be applied to the end effectors

The display step may be performed when the exercise information is input by the user after a recognition step for recognizing the user and when the exercise motion corresponding to a degree of exercise input by the user is stored.

### BRIEF DESCRIPTION OF THE DRAWINGS

FIG. 1 is a view illustrating an AI device constituting a robot system according to an embodiment of the present invention.

FIG. 2 is a view illustrating an AI server of a robot system according to an embodiment of the present invention.

FIG. 3 is a view illustrating an AI system applying a robot system according to an embodiment of the present invention.

FIG. 4 is a front view of a robot arm in a waiting mode according to an embodiment of the present invention.

FIG. 5 is a front view of a robot system in shoulder pressing according to an embodiment of the present invention.

FIG. 6 is a front view of a robot system in chest flying according to an embodiment of the present invention.

FIG. 7 is a side view of a robot system in rowing according to an embodiment of the present invention.

FIG. 8 is a flowchart illustrating an example of a method for controlling a robot system according to an embodiment of the present invention.

FIG. 9 is a flowchart illustrating another example of a method for controlling a robot system according to an embodiment of the present invention.

### DETAILED DESCRIPTION OF THE EMBODIMENTS

Hereinafter, specific embodiments of the present invention will be described in detail with reference to the accompanying drawings.

<Robot>

A robot may refer to a machine that automatically processes or operates a given task by its own ability. In particular, a robot having a function of recognizing an environment and performing a self-determination operation may be referred to as an intelligent robot.

Robots may be classified into industrial robots, medical robots, home robots, military robots, and the like according to use purposes or fields.

The robot may include a driving unit, which includes an actuator or a motor, and perform various physical operations such as moving a robot joint. In addition, a movable robot may include a wheel, a brake, a propeller, and the like in a driving unit, and may travel on the ground through the driving unit or fly in the air.

<Artificial Intelligence (AI)>

Artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, an initialization function and the like.

The purpose of the learning of the artificial neural network may be to determine the model parameters that minimize a loss function. The loss function may be used as an index to determine optimal model parameters in the learning process of the artificial neural network.

Machine learning may be classified into supervised learning, unsupervised learning, and reinforcement learning according to a learning method.

The supervised learning may refer to a method of learning an artificial neural network in a state in which a label for learning data is given, and the label may mean the correct answer (or result value) that the artificial neural network must infer when the learning data is input to the artificial neural network. The unsupervised learning may refer to a method of learning an artificial neural network in a state in which a label for learning data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep running is part of machine running. In the following, machine learning is used to mean deep running.

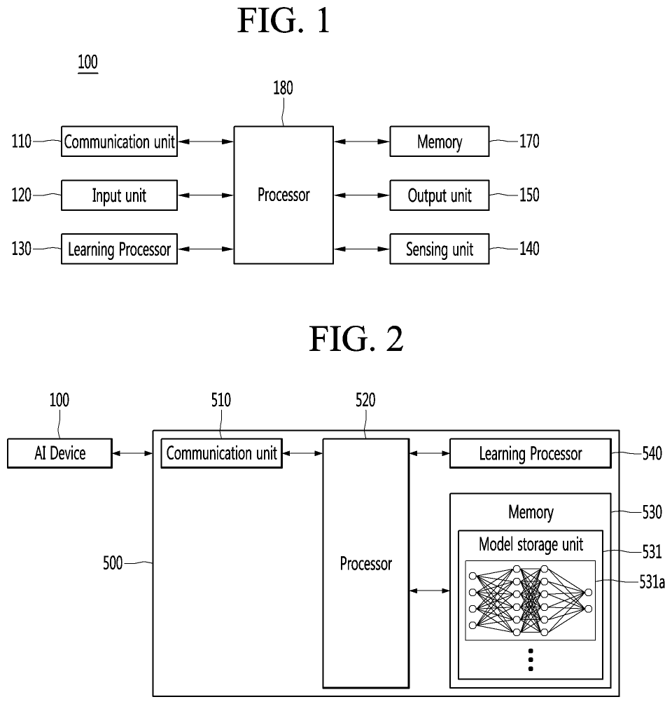

FIG. 1 illustrates an AI device 100 including a robot according to an embodiment of the present invention.

The AI device 100 may be implemented by a stationary device or a mobile device, such as a TV, a projector, a mobile phone, a smartphone, a desktop computer, a laptop computer, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a digital signage, a robot, a vehicle, and the like.

Referring to FIG. 1, the AI device 100 may include a communication unit 110, an input unit 120, a learning processor 130, a sensing unit 140, an output unit 150, a memory 170, and a processor 180.

The communication unit 110 may transmit and receive data to and from external devices such as other AI devices 100a to 100e or an AI server 500 by using wire/wireless communication technology. For example, the communication unit 110 may transmit and receive sensor information, a user input, a learning model, a control signal, and the like to and from external devices.

The communication technology used by the communication unit 110 includes global system for mobile communication (GSM), code division multi access (CDMA), long term evolution (LTE), 5G, wirelsess LAN (WLAN), wireless-fidelity (Wi-Fi), Bluetooth™, radio frequency identification (RFID), infrared data association (IrDA), ZigBee, near field communication (NFC), and the like.

The input unit 120 may acquire various kinds of data.

At this point, the input unit 120 may include a camera for inputting a video signal, a microphone for receiving an audio signal, and a user input unit for receiving information from a user. The camera or the microphone may be treated as a sensor, and the signal acquired from the camera or the microphone may also be referred to as sensing data or sensor information.

The input unit 120 may acquire learning data for model learning and an input data to be used when an output is acquired by using a learning model. The input unit 120 may also acquire raw input data, and in this case, the processor 180 or the learning processor 130 may extract an input feature by preprocessing the input data.

The learning processor 130 may learn a model composed of an artificial neural network by using learning data. The learned artificial neural network may be referred to as a learning model. The learning model may be used to infer a result value for new input data rather than learning data, and the inferred value may be used as a basis for determination to perform a certain operation.

At this point, the learning processor 130 may perform AI processing together with the learning processor 540 of the AI server 500.

At this point, the learning processor 130 may include a memory integrated or implemented in the AI device 100. Alternatively, the learning processor 130 may be implemented by using the memory 170, an external memory directly connected to the AI device 100, or a memory held in an external device.

The sensing unit 140 may acquire at least one of internal information about the AI device 100, ambient environment information about the AI device 100, or user information by using various sensors.

Examples of the sensors included in the sensing unit 140 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, a radar, or the like.

The output unit 150 may generate an output related to a visual sense, an auditory sense, a haptic sense, or the like.

At this point, the output unit 150 may include a display unit for outputting time information, a speaker for outputting auditory information, and a haptic module for outputting haptic information.

The memory 170 may store data that supports various functions of the AI device 100. For example, the memory 170 may store input data acquired by the input unit 120, learning data, a learning model, a learning history, and the like.

The processor 180 may determine at least one executable operation of the AI device 100 based on information determined or generated by using a data analysis algorithm or a machine learning algorithm. The processor 180 may control the components of the AI device 100 to execute the determined operation.

To this end, the processor 180 may request, search, receive, or utilize data of the learning processor 130 or the memory 170, and control the components of the AI device 100 to execute the predicted operation or the operation determined to be desirable among the at least one executable operation.

When the connection of an external device is required to perform the determined operation, the processor 180 may generate a control signal for controlling the external device and may transmit the generated control signal to the external device.

The processor 180 may acquire intention information for the user input and may determine the user's requirements on the basis of the acquired intention information.

The processor 180 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least a part of which is learned according to the machine learning algorithm. In addition, at least one of the STT engine or the NLP engine may be learned by the learning processor 130, may be learned by the learning processor 540 of the AI server 500, or may be learned by distributed processing.

The processor 180 may collect history information including the operation contents of the AI device 100 or the user's feedback on the operation and may store the collected history information in the memory 170 or the learning processor 130 or transmit the collected history information to the external device such as the AI server 500. The collected history information may be used to update the learning model.

The processor 180 may control at least a part of the components of the AI device 100 so as to drive an application program stored in the memory 170. Furthermore, the processor 180 may operate two or more of the components included in the AI device 100 in combination so as to drive the application program.

FIG. 2 illustrates an AI server 500 connected to a robot according to an embodiment of the present invention.

Referring to FIG. 2, an AI server 500 may refer to a device that learns an artificial neural network by using a machine learning algorithm or uses a learned artificial neural network. Here, the AI server 500 may include a plurality of servers to perform distributed processing, or may be defined as a 5G network. At this point, the AI server 500 may be included as a partial configuration of the AI device 100, and may perform at least a part of the AI processing together.

The AI server 500 may include a communication unit 510, a memory 530, a learning processor 540, a processor 560, and the like.

The communication unit 510 can transmit and receive data to and from an external device such as an AI device 100.

The memory 530 may include a model storage unit 531. The model storage unit 531 may store a learning or learned model (or an artificial neural network 531a) through the learning processor 540.The learning processor 540 may teach the artificial neural network 531a by using the learning data. The learning model may be used in a state of being mounted on the AI server 500 of the artificial neural network, or may be used in a state of being mounted on an external device such as the AI device 100.

The learning model may be implemented in hardware, software, or a combination of hardware and software. When all or parts of the learning models are implemented in software, one or more instructions that constitute the learning model may be stored in the memory 530.

The processor 560 may infer a result value for new input data by using the learning model and may generate a response or a control command based on the inferred result value.

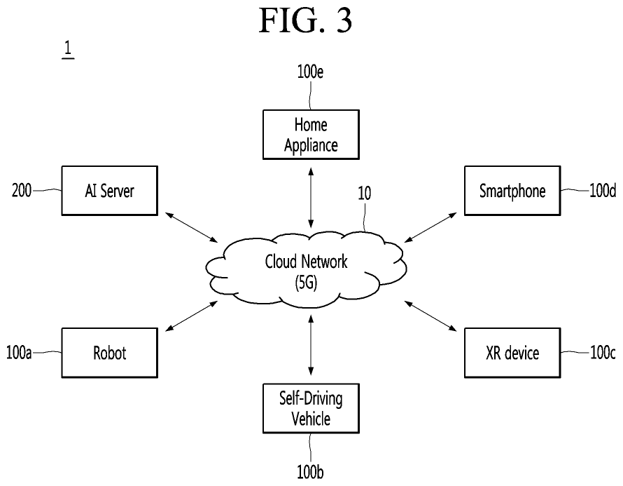

FIG. 3 illustrates an AI system 1 according to an embodiment of the present invention.

Referring to FIG. 3, in the AI system 1, at least one of an AI server 500, a robot 100a, a self-driving vehicle 100b, an XR device 100c, a smartphone 100d, or a home appliance 100e is connected to a cloud network 10. Here, the robot 100a, the self-driving vehicle 100b, the XR device 100c, the smartphone 100d or the home appliance 100a to 100e, which apply AI technology, may be referred as AI devices 100a to 100e.

The cloud network 10 may refer to a network that forms a part of cloud computing infrastructure or exists in a cloud computing infrastructure. The cloud network 10 may be configured by using a 3G network, a 4G network, a long term evolution (LTE) network or a 5G network.

That is, the devices 100a to 100e and 500 constituting the AI system 1 may be connected to each other through the cloud network 10. In particular, each of the devices 100a to 100e and 500 may communicate with each other through a base station, but may directly communicate with each other without using a base station.

The AI server 500 may include a server that performs AI processing and a server that performs operations on big data.

The AI server 500 may be connected to at least one of the AI devices constituting the AI system 1, that is, the robot 100a, the self-driving vehicle 100b, the XR device 100c, the smartphone 100d or the home appliance 100e through the cloud network 10, and may assist at least a part of AI processing of the connected AI devices 100a to 100e

At this point, the AI server 500 may learn the artificial neural network according to a machine learning algorithm instead of the AI devices 100a to 100e, and may directly store the learning model, or transmit the leaning model to the AI devices 100a to 100e.

At this point, the AI server 500 may receive input data from the AI devices 100a to 100e, may infer a result value for the input data received by using a learning model, may generate a response or a control command based on the inferred result value, and may transmit the response or control command to the AI devices 100a to 100e.

Alternatively, the AI devices 100a to 100e may infer the result value for the input data by directly using the learning model and may generate the response or the control command based on the inference result.

Hereinafter, various embodiments of the AI devices 100a to 100e to which the above-described technology is applied will be described. The AI devices 100a to 100e illustrated in FIG. 3 may be regarded as a specific embodiment of the AI device 100 illustrated in FIG. 1.

<AI+Robot>

The robot 100a, to which AI technology is applied, may be implemented as a guide robot, a carrying robot, a cleaning robot, a wearable robot, an entertainment robot, a pet robot, an unmanned flying robot, or the like.

The robot 100a may include a robot control module for controlling the operation, and the robot control module may refer to a software module or a chip implementing the software module by hardware.

The robot 100a may acquire state information about the robot 100a by using sensor information acquired from various kinds of sensors, may detect (recognize) the surrounding environment and an object, may generate map data, may determine the route and the travel plan, may determine the response to user interaction, or may determine the operation.

The robot 100a may use the sensor information acquired from at least one sensor among the lidar, the radar, and the camera so as to determine the travel route and the traveling plan.

The robot 100a may perform the above-described operations by using the learning model composed of at least one artificial neural network. For example, the robot 100a may recognize the surrounding environment and the object by using the learning model, and may determine the operations by using the recognized surrounding environment or the object information. The learning model may be learned directly from the robot 100a or may be learned from an external device such as the AI server 500.

At this point, the robot 100a may perform the operations by generating the result by directly using the learning model, but the sensor information may be transmitted to the external device such as the AI server 500 and the generated result may be received to perform the operation.

The robot 100a may use at least one of the mad data, the object information detected form the sensor information, or the object information acquired from the external device to determine the travel route and the traveling plan, and may control the driving unit such that the robot 100a travels along the determined travel route and the traveling plan.

The map data may include object identification information about various objects arranged in the space in which the robot 100a moves. For example, the map data may include the object identification information about fixed objects such as walls or doors, or movable objects such as pollen and desks. The object identification information may include a name, a type, a distance, a position and the like.

In addition, the robot 100a may perform the operation or travel by controlling the driving unit based on the control/interaction of the user. At this point, the robot 100a may acquire the intention information of the interaction due to the user's operation of speech utterance, and may determine the response based on the acquired intention information and may perform the operations.

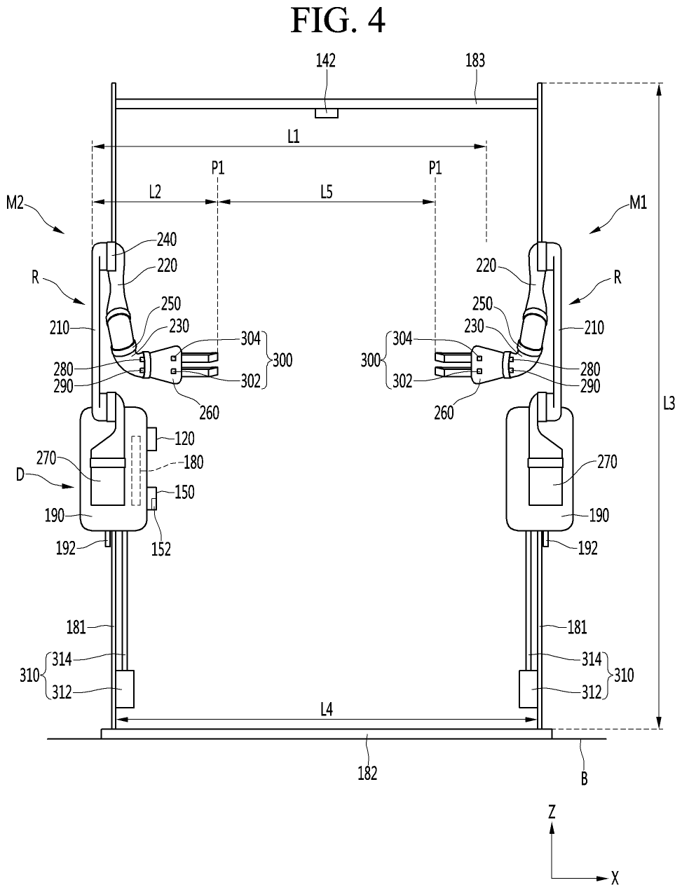

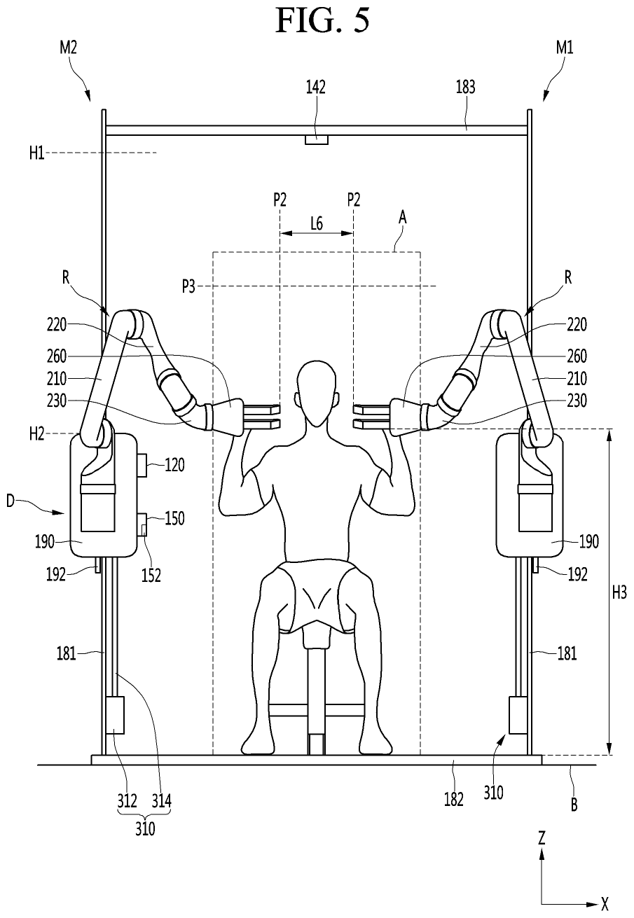

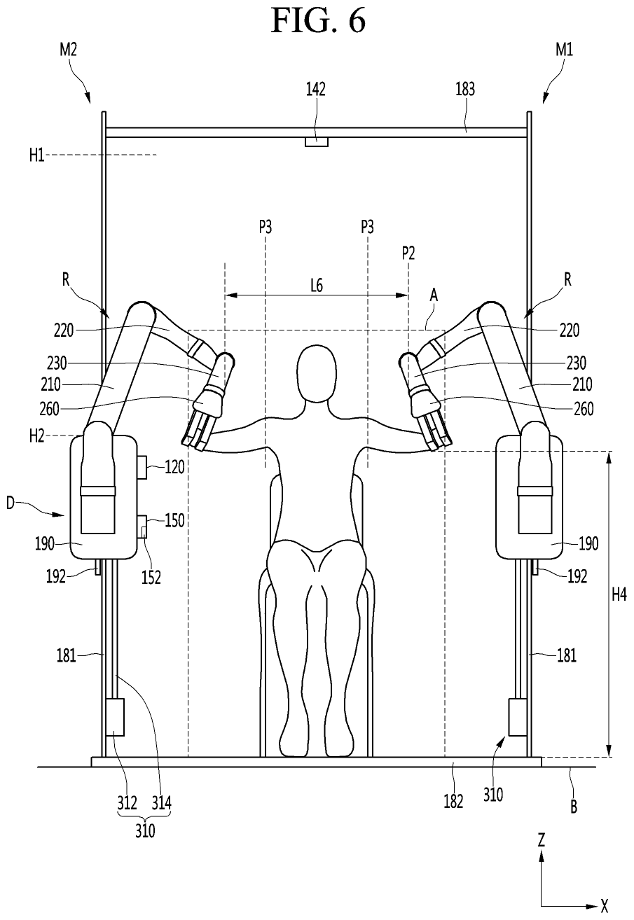

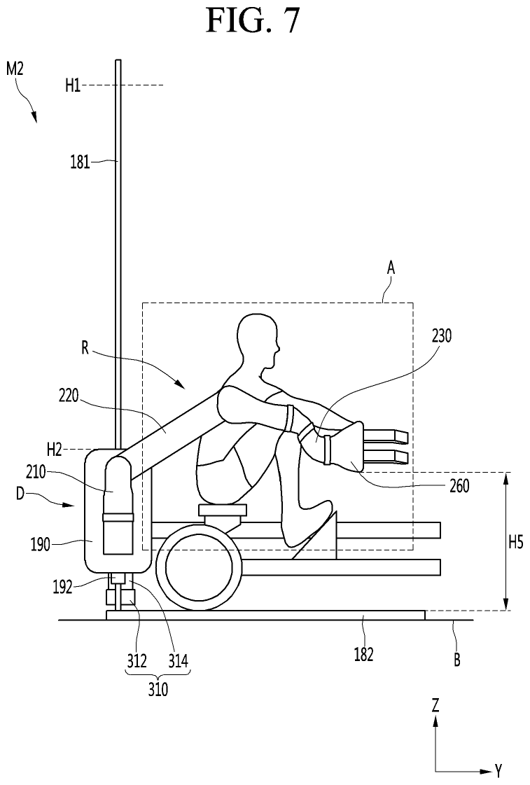

FIG. 4 is a front view of a robot arm in a waiting mode according to an embodiment of the present invention, FIG. 5 is a front view of a robot system in shoulder pressing according to an embodiment of the present invention, FIG. 6 is a front view of a robot system in chest flying according to an embodiment of the present invention, and FIG. 7 is a side view of a robot system in rowing according to an embodiment of the present invention.

A robot system of the embodiment may include a pair of robot arms R and the heights of the respective robot arms R may be adjusted. The respective heights of the pair of the robot arms R may be changed so as to assist various exercises of multiple users having mutually different heights.

The robot system may include a left exercise module M1 and a right exercise module M2 which are horizontally spaced apart from each other. The left exercise module M1 and the right exercise module M2 may be spaced apart from each other in the left-right direction X with an exercise region A, which is a region of user's exercise, interposed between.

Each of the left exercise module M1 and a right exercise module M2 may include a robot arm R and the respective heights of the robot arms R may be configured to be adjusted.

Each of the left exercise module M1 and a right exercise module M2 may be configured to be the same as each other, and be arranged to be horizontally symmetric. The left exercise module M1 and a right exercise module M2 which are spaced from each other in the left-right direction X may constitute the robot 100a, in particular, a multi health robot which may assist various exercises of a user.

Each of the left exercise module M1 and a right exercise module M2 may include a lifting guide 181, a carrier 190 vertically guided along the lifting guide 181, and a robot arm R installed on the carrier 190.

The lifting guide 181 may be installed to be vertically erected on the bottom of sports facility and installed vertically on a separate base 182 that is placed on the bottom.

The lifting guide 181 may be longitudinally arranged in the vertical direction Z.

The upper end of the lifting guide 181 may be formed in a free end.

The robot system may further include an upper connector 183 which connects the upper ends of the lifting guide 181 of the left exercise module M1 and the lifting guide 181 of the right exercise module M2.

Each of the carriers 190 may be lifted or lowered along the lifting guide 181 and may be a robot arm height adjustment mechanism that adjusts the height of the robot arm R.

A groove or a rib may be longitudinally formed in the vertical direction in any one of the carrier 190 and the lifting guide 181, and a protrusion part guided along the groove or the rib in the other among the carrier 190 and the lifting guide 181 may be formed.

Each of the left exercise module M1 and a right exercise module M2 may further include a carrier locker 192 that fixes the carrier 190.

The carrier locker 192 may include: a locking body which is disposed on any one of the lifting guide 181 and the carrier 190 so as to be moved or rotated toward the other; and a locking body driving source such as a motor or a switch that operates the locking body so as to move or rotate the locking body.

A stopper to which the locking body is inserted and locked to the locking body may be provided to the other of the lifting guide 181 and the carrier 190.

In a locking mode of the locking body driving source, the locking body may be locked to the stopper by being moved or rotated toward the stopper, and in this case, the carrier 190 may keep the current position without being lifted or lowered along the lifting guide 181.

In the locking mode of the locking body driving source, the locking body may be released from the stopper, and in this case, the carrier 190 may be in a vertically movable state along the lifting guide 181.

The carrier locker 192 may be installed on the carrier 190, a plurality of stoppers may be formed on the lifting guide, and the plurality of stoppers may be formed to be spaced apart from each other in the vertical direction Z.

Meanwhile, the robot system may include an input part 120 for a user input. The input part 120 may include a microphone or a touch panel. The input part 120 may be arranged on the carrier 190.

The input part 120 may be disposed on the carrier 190 of each of the left exercise module M1 and a right exercise module M2, and may also be disposed on the carrier 190 of either of the left exercise module M1 and a right exercise module M2.

The input part 120 may be arranged to face toward an exercise region in the horizontal direction. The user located on the exercise region A may conveniently input various commands through the input part 120 adjacent to the exercise region A.

The robot system may include a speaker 152 that provides a user with voice guidance. The speaker 152 may constitute an output part 150 that provides various pieces of information by sound. The output part 150 may include a touch screen provided to the touch panel. The speaker 152 may be arranged on the carrier 190.

The output part 150 may be disposed on the carrier 190 of each of the left exercise module M1 and a right exercise module M2, and may also be disposed on the carrier 190 of either of the left exercise module M1 and a right exercise module M2.

The output part 150 may be arranged to face toward an exercise region in the horizontal direction. A user located in the exercise region A may acquire, with high reliability in a comfortable posture, various sound information or display information output through the output part 150 adjacent to the exercise region A.

When at least one of the input part 120 and the output part 150 is arranged on the carrier 190, an assembly D of the carrier 190, the input part 120, and the output part 150 may constitute a raising/lowering interface module that is lifted/lowered to match the height of the user located in the exercise region.

The robot system may include a controller 180 that controls robot arms R and carrier lifting mechanisms to be described later.

The controller 180 may be disposed on the carrier 190, and in this case, a movable control module that is lifted/lowered to match the height of the user located on the exercise region of the assembly D of the carrier 190 and the controller 180.

The robot arms R may each include at least one arm 210, 220 and 230 and an end effector 260 connected to the arm.

The robot arms R may each include a plurality of arms 210, 220 and 230 and at least one arm connector 240 and 250. The plurality of arms 210, 220 and 230 may be sequentially arranged with the arm connectors 240 and 250 interposed therebetween.

The end effectors 260 may each be installed on any one 230 among the plurality of arms 210, 220 and 230. The end effectors 260 may each be a robot hand or a gripper, and may function as a kind of handle that may be gripped by the hand of a user. The end effectors 260 may each be connected to any one 230 among the plurality of arms 210, 220 and 230.

The robot arms R may each be fixed to the carrier 190 and have height that may be adjusted by the carrier 190. The robot arms R may each further include the carrier connector 270 fastened to the carrier 190.

Referring to FIG. 4, the robot arms R may each be unfolded or folded within the range from the minimum length L2 to the maximum length L1.

The maximum length L1 of each robot arm R may be the total length of the robot arm when the robot arm R when the robot arm R is maximally unfolded with respect to the carrier 190 or to the carrier connector 270. The maximum length L1 of the robot arm R may be defined as the total horizontal length of the robot arm R when the robot arm R is maximally unfolded.

The minimum length L2 of the robot arm R may be defined as the total length of the robot arm R when the robot arm R is maximally folded. The minimum length L2 of the robot arm R may be defined as the total horizontal length of the robot arm R when the robot arm R is maximally folded.

The maximum length L1 of the robot arm R may be smaller than the length L3 of the lifting guide 181. The maximum length L1 of the robot arm R may be smaller than the distance L4 between the lifting guide 181 of the left exercise module M1 and the lifting guide 181 of the right exercise module M2.

In this case, when the robot arm R of the left exercise module M1 is maximally unfolded, collision of the robot arm R of the left exercise module M1 to the carrier 190 or the robot arm R of the right exercise module M2 may be minimized.

In addition, when the robot arm R of the right exercise module M2 is maximally unfolded, collision of the robot arm R of the right exercise module M2 to the carrier 190 or the robot arm R of the left exercise module M1 may be minimized.

The robot system may further include: torque sensors 280 that sense torque of the arms 210, 220 and 230; and angle sensors 290 that sense the angles of the arms 210, 220 and 230.

The torque sensors 280 may each be provided to each of the arms, and be provided so that a single torque sensor senses the torque of the arm 230 most adjacent to the end effector 260 among the plurality of arms 210, 220 and 230.

The angle sensors 290 may each sense the rotated angle of the arm to be sensed with respect to the other arm adjacent to the arm. The angle sensors 290 may be provided to each of the arms, and be provided so that a single angle sensor senses the torque of the arm 230 most adjacent to the end effector 260 among the plurality of arms 210, 220 and 230.

The robot arms R may further include end effector sensors 300 installed to the respective end effectors 260.

The end effector sensors 300 may each further include a touch sensor 302 that senses the touch of a user. The end effector sensors 300 may each further include a force sensor that senses the force applied to the corresponding end effector.

The user may hold, in particular, the end effector 260 of the robot arm R and apply a force (that is, an external force) to the end effector 260 in the direction in which the position and the angle of the end effector 260.

When the user holds the end effector 260 by the hand, the touch sensor 302 may sense the touch of the user, and transmit the sensed value to the controller 180.

The touch sensors 302 are sensors that may sense the contact or touch of the user and may include a capacitive type, a variable electrical conductivity (variable resistance type), a variable light amount type, and the like. Of course, the types or the methods of the touch sensors 302 are not limited as long as having configurations that may sense the physical contact of the user.

When there is a s touch of a user, the touch sensors 320 may transmit whether to be touched to the controller 180, and when the user does not hold the end effector any longer, the touch sensors may transmit to the controller 180 whether not to be touched.

The force sensors 304 use a method for converting a force into an electrical quantity, and may be divided into a method of using deformation of an elastic body as a first conversion element and a method of tacking equilibrium between the amount to be measured and a force with an already known magnitude.

Force sensors using deformation of an elastic body include a type that detects strain itself, a type that uses a physical effect due to deformation, and a type that uses variation in vibration frequency due to deformation. Of course, the types and methods of the force sensors 304 are not limited as long as the force sensor may measure a force applied to the end effector 260 by a user for an exercise.

When the user holds the end effector 260 and applies an external force, the force sensors 304 may sense the external force and transmit the sensed value to the controller 180. When the user holds the end effector 260 and takes a motion for an exercise, the external force sensed by the force sensors 304 may vary according to the positions or angles of the end effectors 260, and the force sensors 304 may continuously transmit, to the controller 180, the sensed value of the force according to a time elapse.

The robot system may further include lifting mechanisms 310 that raise/lower the carriers 190.

In the robot system, a user or an operator (hereinafter, referred to as a user) may manually raise/lower the carriers 190 without the lifting mechanisms 310, and the lifting mechanisms 310 rather than the user may also raise/lower the carriers 190.

In the robot system, while a user rotates or moves a part of the robot arms R by applying an external force to the robot arms R, the carriers 190 may be lifted/lowered together with the motion of the robot arms R.

In the robot system, when the carriers 190 are lifted or lowered while the motions of the robot arms R are generated, more various composite exercise motions may be generated than the case in which only the robot arms R are moved while the positions of the carriers 190 are fixed, and the carriers 190 may favorably be lifted/lowered by the lifting mechanisms 300 while the robot arms R are moving. In this case, the robot system may generate a whole exercise motion by the motion of the robot arms R and by raising/lowering the carriers 190.

Hereinafter, an example in which a robot system includes a lifting mechanism 310 will be described. However, of course, the present invention is not limited to raise/lower the carriers 190 by the lifting mechanisms 310, and the height of the carriers 190 are manually adjusted by a user.

The lifting mechanisms 310 may each include a linear motor connected to the carrier 190, and may include: a motor 312 such as a servomotor or a linear motor; and at least one power transmission member 314 such as a gear, a belt, or a linear guide that transmits the driving force of the motor to the carrier 190.

The lifting mechanisms 310 may each raise or lower the carrier 190 to a height suitable for the movement selected by a user before the user starts the exercise, and may fix the position of the carrier 190 without varying the height of the carrier 190 while the user performs the exercise.

The lifting mechanisms 310 may each raise or lower the carrier 190 to a height suitable for the movement selected by a user before the user starts the exercise, and may raise or lower the height of the carrier 190 in a pre-programmed control sequence while the user performs the exercise.

While the user performs an exercise, whether to raise/lower the carrier 190 by the lifting mechanisms 310 may be different according to the type of the movement selected by the user, and the robot system may optimally deal with the exercise input by the user via the input part 120.

The lifting mechanisms 310 may raise/lower, to the same height, the carrier 190 of the left exercise module M1 and the carrier 190 of the right exercise module M2, or may raise/lower, to the mutually different heights, the carrier 190 of the left exercise module M1 and the carrier 190 of the right exercise module M2.

An example of the lifting mechanisms 310 may be provided for each of the left exercise module M1 and the right exercise module M2, and in this case, the heights of the carrier 190 of the left exercise module M1 and the carrier 190 of the right exercise module M2 may be adjusted to be the same or be mutually different.

In another example, the lifting mechanisms 310 may include one driving source and two sets of power transmission members and operate the two sets of power transmission members by the one driving source. In this case, the robot system may adjust the heights of the carrier 190 of the left exercise module M1 and the carrier 190 of the right exercise module M2 to be the same.

According to the type of the exercise, the height of any one of the carrier 190 of the left exercise module M1 and the carrier 190 of the right exercise module M2 may be larger than the height of the other one, and the lifting mechanisms 310 may favorably be provided for each of the left exercise module M1 and the right exercise module M2. However, the present invention is, of course, not limited to provide the lifting mechanisms 310 for each of the left exercise module M1 and the right exercise module M2.

The robot system may further include a controller that controls each of the left exercise module M1 and the right exercise module M2.

The controller may control the robot arms R. When the robot system further includes the lifting mechanisms 310, the controller may control the robot arms R and the lifting mechanisms 310. The controller may constitute a part of the robot 100a and also constitute the entirety of or a part of the server 500 to which the robot 100a is connected.

The robot 100a constituting the robot system may configure an AI device, which performs motion operation related to an exercise, using an artificial neural network, and may generate various motions by the data pre-stored in a memory 170 and a program of a processor 180. Hereinafter, for the convenience in description, a controller will be described by using the same reference numeral 180 as the processor.

The controller may control the robot arms R in a plurality of modes.

The plurality of modes may include a waiting mode and an exercise mode.

The waiting mode may be a mode in which the robot arms R, in particular, the end effector 260 keeps the position thereof by being moved to a waiting position P1.

In the waiting mode, the robot arm R of the left exercise module M1 and the robot arm R of the right exercise module M2 may be spaced a first distance L5 (see FIG. 4) apart from each other.

The exercise mode may be a mode in which the robot arms R, in particular, the end effectors 260 are moved to an exercise region A in which the end effectors may be moved by a user, and the hand of the user may easily approach the end effectors of the robot arms R.

In the exercise mode, the robot arm R of the left exercise module M1 and the robot arm R of the right exercise module M2 may be spaced a second distance L6 (see FIG. 5) apart from each other.

The first distance L5 may be larger than the second distance L6.

The first distance L5 in the waiting mode may not be different for each of various exercises set by a user, but be constant.

As illustrated in FIGS. 5 and 6, the second distance L6 in the exercise mode may be different for various types of exercises input by the user.

The second distance L6 may be a variable distance that may vary according to the types of exercises provided by the robot system.

The controller 180 may control the lifting mechanism 310 in a plurality of modes.

The plurality of modes may include an initial mode and an adjustment mode.

In the initial mode, the controller 180 may control the lifting mechanism 310 so that the carriers 190 are located at carrier waiting positions H1.

The carrier waiting position H1 may be a position at which the carriers wait when an exercise is not performed by using the pair of robot arms R, and the carrier waiting position H1 may be a position set to a predetermined height of the lifting guide 181.

For example, the carrier waiting position may be set to the position when the carriers 190 are lifted to the maximum height along the lifting guides 181, to the position when the carriers 190 are lowered to the minimum height along the lifting guides 181, or to the position when the carriers 190 are at a reference height between the maximum height and the minimum height.

The lifting mechanism 310 may be operated in the adjustment mode before a user starts an exercise while waiting for the carriers 190 at the carrier waiting position H1, and may move the carriers 190 to an optimal initial position.

In the adjustment mode, the controller 180 may control the lifting mechanism 310 so that the carriers 190 are located at an optimal initial position H2.

The optimal initial position H2 may be the position of the carriers 190 when the carriers are at the height that the user easily may approach. The optimal initial position H2 may be a position of the carriers 190 when the carrier 190 is at the height at which the carriers 190 face an exercise region A. The optimal initial position H2 may be different according to the exercise type input by the user and the height of the user, and the controller 180 may determined the optimal initial position H2 to be different according to the exercise type input by the user and the height of the user.

In the robot system, when the carriers 190 are at the carrier waiting position H1, the end effectors 260 of the robot arms R may be positioned at the waiting positions P1.

In the robot system, under conditions of such the positions H1 and P1, the carriers 190 may be lifted to the optimal initial position H2, and in this case, when the carriers 190 are at the optimal initial position H2, the end effectors 260 of the robot arms R may be positioned at the waiting position P1 in the robot system.

In the robot system, under such a condition of positions H2 and P2, the end effectors 260 of the robot arms R may be moved from the waiting position P1 to the exercise region A, and in particular, may be moved to an exercise initial position P2 in an exercise region A. In this case, in the robot system, when the carriers 190 are at the optimal initial position H2, the end effectors 260 of the robot arms R may be positioned at the exercise initial position P2, and the robot system is in a state in which the user may hold the end effectors 260 or the arms 230 approaching the end effectors 260 and start an exercise.

In the robot system, the robot arms R may be operated in an exercise motion under a condition of positions H2 and P2.

The robot arms R may move the end effectors 260 of the robot arms R along a set trajectory so that the end effector 260 moves to an exercise final position P3, may repeatedly moves the end effectors 260 to the exercise initial position P2 and the exercise final position P3, may provide a weight feeling to the user while the end effectors 260 moves to the exercise initial position P2 and the exercise final position P3 at least two times.

FIGS. 5 to 7 are views in which a user uses a robot system to perform various kinds of exercises, and when robot arms R are operated in an exercise, an exercise region A and the heights H3, H4 and H4 of end effectors may be mutually different.

As illustrated in FIG. 5, when the height H3 (first height H3) of the end effectors is large, and the end effectors 260 are higher than the height of the shoulder of the user or approach the height of the shoulder, the user may perform a motion of vertically raising or lowering arms 230 while holding the arms 230 adjacent to the end effectors 260 among the end effectors 260 and a plurality of arms 210, 220 and 230 of the robot arms R.

The robot arms R for such an exercise may be controlled such that the position and the angle of some arms adjacent to carrier connectors 270 among the first arms 210 are fixed, and that the second arms 220, and the third arms 230, and the arms adjacent to the end effectors 260 are vertically lifted or lowered.

In this case, as illustrated in FIG. 5, the robot system in which the heights of the carriers 190 and the positions of the robot arms R are determined may function as a shoulder press machine.

As illustrated in FIG. 6, in the robot arms R, the height H4 (second height H4) of the end effectors 260 may be lower than the shoulder of a user, the arms 230 adjacent to the end effectors 260 may be positioned to the position and the height adjacent to the chest of the user, and the user may perform a motion (exercise) of causing the arms 230 to be close to or away from each other in the horizontal direction. That is, the second height H4 may be lower than the first height H3.

The robot arms R for such an exercise may be controlled such that the position and angle of some arms adjacent to carrier connectors 270 are fixed, and that the arms adjacent to the end effectors 260 are rotated or moved.

As illustrated in FIG. 6, the robot system in which the heights of the carriers 190 and the positions of the robot arms R are determined may function as a chest fly machine.

As illustrated in FIG. 7, the height H5 (third height H5) of robot arms, particularly, the end effectors 260 may be low, and a user may perform a motion similar to rowing while holding the end effectors 260 or arms 230 adjacent to the end effectors 260. The third height H5 may be lowers than the second height H3.

In the robot arms R for such an exercise, the position and angle of each of the first arms 210, the second arms 220 and the third arms 230 may be fixed and be adjusted so that the total lengths of the robot arms R increase or decrease.

As illustrated in FIG. 7, the robot system in which the heights of the carriers 190 and the positions of the robot arms R are determined may function as a rowing machine.

The robot system may provide various combinations of exercise motions by the heights of carriers 190, the number of arms having variable positions or angles among robot arms R, and the like, and in this case, a new kind of exercise may be induced by a pair of robot arms R and a pair of carriers 190 which were not provided by existing exercise machines.

The robot system may deal with various new exercises by updating data about various exercise information stored in a memory 170 or a program of a processor 180.

Meanwhile, the robot system may include a sensing unit 140 that may capture the image of a user located around a left exercise module M1 or a right exercise module M2, and the sensing unit 140 may include a vision sensor that may capture the image of the body of the user. The vision sensor 142 may be installed at the height at which the height or the like of the user may be sensed, and be installed on a lifting guide of the left exercise module M1, a lifting guide of the right exercise module M2, a base 182, or an upper connector 183. Such the vision sensor may be configured from an RGB camera or an RGB-D camera, and may capture the height of the user, a pause taken by the user, or the like and transmit the capturing result to a controller 180.

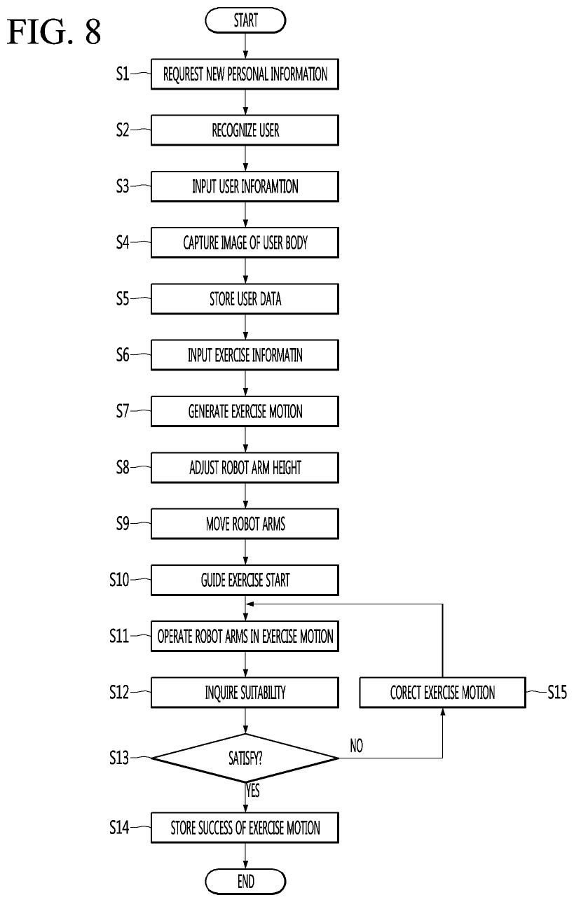

FIG. 8 is a flowchart illustrating an example of a method for controlling a robot system according to an embodiment of the present invention.

The method for controlling a robot system according to the embodiment may control the robot system including: carriers 180 in which a left exercise module M1 and a right exercise module M2 are lifted/lowered and guide along respective lifting guides; and robot arms R having heights that may be varied by the carriers 180.

The method for controlling a robot system may include: capturing steps S1, S2, S3 and S4 for capturing the body of a user by a vision sensor when user information is input by the user; a storing step S5 for storing user data according to the body of the user in a memory; movement steps S6, S7, S8 and S9 for generating an exercise motion determined by the user data and exercise information when the desired exercise information is input by the user and moving end effectors to an exercise region when the user is located at the exercise region; and motion steps S10 and S11 for performing the exercise motion by robot arms R when the user holds the end effectors.

The user information may be information such as the user name/nick name, the age, the height, the weight and the like, and the user may input the user information such as the user name via an input unit 120.

When the user information is input, the vision sensor 142 may capture the image of the user and output the image to the controller 180.

The capturing steps S1, S2, S3 and S4 may include: a user information input step S3 for inputting the user information by the user; and a capturing step S4 for capturing the body of the user.

The capturing steps S1, S2, S3 and S4 may further include: a request step S1 which may be started by the user information input step S3 and which is for requesting new personal information; and a recognition step S2 in which the controller 180 recognizes a user for whom registration of the new personal information has been requested.

In the recognition step S2, the vision sensor 142 and the like may capture the image of the user, and a QR code or an NFC may be sensed by the input unit, and the controller 180 may perform the recognition step S2 by the user face recognition and the recognition of the QR code or the NFC.

In the capturing steps S1, S2, S3 and S4, the capturing step S4 may be performed when the user information input step S3 is performed after the recognition step S2.

The storing step S5 may be started when the image capturing of the user is completed, the controller 180 may generate user data such as a user body shape model and store the data to the memory 170.

The movement steps S6 and S7 may include an exercise information input step S6 for inputting exercise information desired by the user.

The exercise information input step S6 may be started after the storing step S5. The exercise information input step S6 may be performed in which an output unit may display exercise information or notify a user of inputting the exercise information, and the exercise information desired by the user is input to the input unit.

The exercise information input by the user may include the kind, number and strength of exercise, a concentrated exercise muscle, or the like.

For example, when the robot system may provide various exercises such as a shoulder press exercise, a chest fly exercise, and a yawing exercise, the user may select and input a desired exercise among such exercise, select and input a desired number of times among the number of times of exercise such as 10 times or 20 times, select and input a desired strength among the exercise strengths such as 5 kg, 10 kg, 15 kg, or 20 kg, and select and input a desired concentrated exercise muscle among exercise muscles such as a shoulder muscle, a chest muscle, or back muscle.

The exercise information input by the user may not limited to the type, number of times, strength of the exercise and the concentrated exercise muscle described above, and may, of course, various information.

When the exercise information input step S6 is performed, the movement steps S6, S7, S8 and S9 may include an exercise motion generation step S7 for an exercise to be performed.

The exercise motion generation step S7 may be a step for generating an exercise motion to be provided to the user. The controller 180 may calculate the size and position (coordinates) of an exercise region in which the user may perform exercise by the user data (for example, user body shape model) and/or exercise information (for example, kind of exercise), determine an optimal initial position of the robot arms R, and generate an exercise motion suitable for the user body.

The exercise motion generated by the controller 180 may be a motion that reflects the movement/rotation trajectory of the end effectors, the speed of the end effectors, and the like.

The optimal initial position may be a height at which the robot arms R may optimally provide the generated exercise motion when the robot arms R are in a wait mode, and may be determined so that the user data such as the height and the sitting height, the kind of exercise, and the like may be different according to the exercise information.

The movement steps S6, S7, S8 and S9 may include a robot arm height adjustment step S8 performed after the exercise motion generation step S7.

The robot arm height adjustment step S8 may be a step in which the carriers 190 adjust the heights of the robot arms R to be at an optimal initial position H2, and lifting mechanisms may raise or lower the carriers 190 from a carrier waiting position H1 to the optimal initial position H2.

The user may enter an exercise region A in a state in which the robot arms R are in a waiting mode (that is, the end effectors 260 are at waiting position P1), and the robot arms R are located at the optimal initial position H2.

The exercise region A may include the region from the lifting guide 181 of the left exercise module M1 and the lifting guide 181 of the right exercise module M2, the width in the left-right direction thereof may be smaller than the distance between the lifting guide 181 of the left exercise module M1 and the lifting guide 181 of the right exercise module M2, and the length in the front-rear direction Y may be larger than the length in the front-rear direction of each of the lifting guide 181 of the left exercise module M1 and the lifting guide 181 of the right exercise module M2.

The movement steps S6, S7, S8 and S9 may include a robot arm movement step S9 started when the user is located at the exercise region A.

In the movement steps S6, S7, S8 and S9, particularly, in the robot arm movement step S9, whether the user is located at the exercise region may be determined by the image captured by the vision sensor 142.

The robot arm movement step S9 may be a step for moving the robot arms R to the exercise region A, and the controller 180 may control the robot arms R so that the robot arms R, particularly, the end effectors 260 are moved to an exercise initial position P2 within the exercise region A.

The user located at the exercise region A may hold, by the hand, the end effectors 260 move to the exercise initial position P2 in the exercise region A or the arms 230 connected with the end effectors 260. End effector sensors 300 may sense this.

The motion steps S10 and S11 may be started when the end effector sensors 300 sense a touch/grip of the user.

The motion steps S10 and S11 may include a guidance step S10 and the motion step S11.

In the guidance step S10, when the end effector sensors 300 sense the touch/grip of the user, the start of warming-up of then exercise motion may be guided by a voice or a screen through the output unit. The guidance step S10 may be a step for guiding the start of an exercise to the user through the output unit 150.

The motion step S11 may be a step in which the controller 180 operates the robot arms R so that the robot arms R operate in the generated exercise motion. The movement speed of the robot arms R in the motion step S11 may be the same as the speed of the generated exercise motion, may be a speed slower than the speed (for example, 0.3 m/sec) of the generated exercise motion by a set speed (for example, 0.1 m/sec).

The method for controlling the robot system may further include an inquiring step S12 of inquiring the user of the suitability of the present exercise motion via the output unit.

When the user inputs satisfaction via the input unit 120 (S13), the storing steps S13 and S14 may be performed. In the storing steps, the controller 180 may store the success of the exercise motion to the memory 170.

When the user inputs dissatisfaction via the input unit 120, correction steps S13 and S15 are performed, and after the correction steps S13, S15, it is possible to return to the motion steps S10 and S11, particularly, to the motion step S11.

In the correction steps S13 and S15, the controller 180 may generate a new exercise motion in which a specific factor (for example, speed) of the already-performed exercise is corrected, and the motion steps S10 and S11, particularly, to the motion step S11 may be performed by using the corrected exercise motion.

For example, the new exercise motion may be an exercise motion in which the robot arms R operate at a speed faster or slower the speed of the previously performed exercise motion by a correction set speed (for example 0.05 m/sec).

In the inquiring step S12 performed after the correction steps S13 and S15 and the motion step S11, when the user inputs satisfaction (S12), the controller 180 may store, in the memory 170, the success of the new exercise motion to which the user inputs satisfaction for each user.

When performing the abovementioned correction steps S13 and S15 at least once, the robot system may acquire the information about user-satisfied exercise motion and store the information to the memory 170.

The method for controlling the robot system illustrated in FIG. 8 may be a control method which may assist users who firstly use the robot system in registration and first use, and which store, in the memory 170, various information (for example, user information, user data, exercise information, and exercise motion) of the first use considering the case in which a registered user re-uses the robot system.

The user having an experience of using the robot system may reuse the robot system, and in this case, the robot system may be favorably controlled through a control method different from the control method illustrated in FIG. 8.

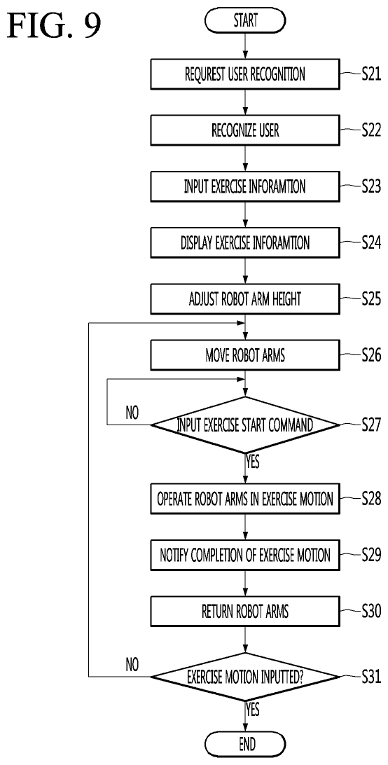

The method for controlling a robot system illustrated in FIG. 9 may be a control method for controlling the robot system when the user, who has a history of using the robot system at least once, reuses the robot system. However, the method for controlling the robot system illustrated in FIG. 9 is not limited to a controlling method for a user reusing the robot system, but may, of course, be applied to a case of firstly using the robot system.

FIG. 9 is a flowchart illustrating another example of a method for controlling a robot system according to an embodiment of the present invention.

Like the method for controlling a robot system of the abovementioned embodiment, the method for controlling a robot system of the present embodiment may include: display steps S21, S22, S23 and S24 in which carriers 190 and robot arms R of respective left exercise module M1 and right exercise module M2 may be controlled, and when a user inputs exercise information, an exercise motion corresponding to the exercise information is displayed on an output unit 150; movement steps S 25 and S26 in which when the user inputs agreement to the displayed exercise motion, end effectors 260 of the robot arms R are moved to an exercise region A; motion steps S27 and S28 in which when the user holds the end effectors 260, the robot arms R perform an exercise motion determined according to the input exercise information; and returning steps S29 and S30 in which after the robot arms R perform the exercise motion, the end effectors 260 of the robot arms R return to a waiting position P1.

The display steps S21, S22, S23 and S24 may include an exercise information input step S3 and a display step S4.

The display steps S21, S22, S23 and S24 may further include a request step S21 in which a user request recognition and a recognition step S22 for recognizing the user, wherein when the recognition step S22 is completed, the exercise information input step S3 may be started.

The request step S21 may be a step in which the user requests for recognition of the user via the input unit 120. The input unit 120 may display a user recognition item in an initial screen, and the user may perform the request step S21 by inputting such the user recognition menu item.

In the recognition step S2, the vision sensor 142 and the like may capture the image of the user face, and a QR code, an NFC or the like of a mobile terminal may be sensed by the input unit, and the controller 180 may perform the recognition step S2 by the user face recognition and the recognition of the QR code, the NFC, or the like.

In the display steps S21, S22, S23 and S24, when the exercise information input step S23 is performed, the display step S24 may be performed.

The exercise information input step S23 may be a step in which desired exercise information is input by the user.

The exercise information input by the user may be the same as the exercise information (the type, number of times, strength and the like of the exercise desired by the user) described in an embodiment of the method for controlling a robot system, and detailed description thereon is not provided so as to avoid an overlapping description.

The display step S24 may be performed when the exercise information step S23 is performed. The display step S24 may be a step for displaying, on the output unit 150, an exercise motion corresponding to the exercise information.

The display step S24 may be a step for displaying an image or a video of the exercise motion through a touch panel or the like constituting the output unit 150.

In the display step S24, when the exercise motion for each user is already stored in the memory 170, the stored exercise motion may be displayed on the output unit 150, and whether to re-perform the already stored exercise motion is displayed to the user.

Conversely, when there is no already stored exercise motion stored in the memory 170, the robot system may be controlled according to the method for controlling the robot system illustrated in FIG. 8.

Meanwhile, when the user wants a different exercise motion from the exercise motion output by the output unit 150, the user may input whether to want another exercise motion via the input unit 120, and in this case, the robot system may be controlled by the control method illustrated in FIG. 8.

When the user wants the already stored exercise motion, whether to agree to the exercise motion may be input by the input unit 120, and the controller 180 may start the movement steps S25 and S26 in which the end effectors 260 of the robot arms are moved to the exercise region A in order to prepare the agreed exercise motion.

The movement steps S25 and S26 may include a robot arm height adjustment step S25 performed when the agreement of the user is input.

The robot arm height adjustment step S25 of the present embodiment illustrated in FIG. 9 may be performed in the same manner as the robot arm height adjustment step S8 of the one embodiment illustrated in FIG. 8, and in the robot arm height adjustment step S25, the lifting mechanism 310 may raise/lower the carriers 190 from a carrier waiting position H1 to an optimal initial position H2 and at this point, the robot arms R may face the exercise region A of the exercise motion to which the user agreed.

The user may enter the exercise region A in a state in which the robot arms R are in a waiting mode (that is, the end effectors 260 are at a waiting position P1), and the robot arms R are located at the optimal initial position H2.

The movement steps S25 and S26 may include the robot arm movement step S26 started when the user is located at the exercise region A.

The robot arm height adjustment step S25 of the present embodiment illustrated in FIG. 9 may be performed in the same manner as the robot arm height adjustment step S9 of the one embodiment illustrated in FIG. 8.

In the movement steps S25 and S26, particularly, in the robot arm movement step S26, whether the user is located at the exercise region may be determined by the image captured by a vision sensor 142.

In the robot arm movement step S26, the controller 180 may control the robot arms R so that the robot arms R, particularly, the end effectors 260 are moved to an exercise initial position P2 within the exercise region A, and the user located at the exercise region A may hold, by the hand, the end effectors 260 moved to the exercise initial position P2 within the exercise region A or arms 230 to which the end effectors are connected. End effector sensors 300 may sense this.

The motion steps S27 and S28 may be performed after the movement steps S25 and S26.

The controller 180 may notify an exercise start via the output unit 150 after the movement steps S25 and S26, and the user may input an exercise start command via the input unit 120 (S27).

The motion steps S27 and S28 may include: an input step S27 in which the user inputs an exercise start command; and a motion step S28 for operating the robot arms R in the exercise motion.

In the motion steps S27 and S28, the motion step S28 may be performed in which when the user holds the end effectors 260, this is sensed, and the robot arms R may immediately be operated in the exercise motion, and when the user holds the end effectors 260 and inputs the exercise start command, the motion step S28 of operating the robot arms R in the exercise motion determined according to the input exercise information may be performed.

In the motion steps S27 and S28, particularly, in the motion step S28, a torque corresponding to the exercise strength may be applied to the end effectors 260 of the robot arms.

In the motion step S28, the robot arms R may perform, a predetermined number of times (reference number of times) included in the exercise information, the movement of the end effectors 260 to the exercise initial position P2 and an exercise final position P3.

The robot arms R, particularly, the end effectors 260 completes the exercise motion, the motion step S28 may be completed, and the return steps S29 and S30 may be started.

The return steps S29 and S30 may include an exercise motion completion alarm step S29 and a return step S30.

The exercise motion completion alarm step S29 may be started when the movement of the end effectors 260 to the exercise initial position P2 and the exercise final position P3 are completely performed the predetermined number of times included in the exercise information, and the controller 180 may output the completion of the entirety of the exercise motion to the output unit 150.

In the return step S30, the end effectors 260 of the robot arms R may be moved from the exercise region A, particularly, from the exercise initial position P2 or the exercise final position P3 to the waiting position P1.

In the return steps S29 and S30, it is of course possible to omit the exercise motion completion step S29 and perform the return step S30 in which the end effectors 260 are moved from the exercise region A to the waiting position P1.

In the method for controlling the robot system, after the return step S30, the user may input exercise completion via the input unit 120, and in a state in which the user does not input the exercise completion via the input unit 120, the user may reenter the exercise region A after a predetermined-time rest (S31).

The reentrance of the user to the exercise region A may be sensed by the vision sensor 142 and subsequently, the robot system may perform the robot arm movement step S26. As described above, the subsequent steps (S26 to S31) may be performed after the robot arm movement step (S26).

According to embodiments of the present invention, by using a pair of robot arms and a pair of carriers, a single robot system may provide each of multiple users having different body sizes with various kinds of exercise effects.

The foregoing description is merely illustrative of the technical idea of the present invention and various changes and modifications may be made by those skilled in the art without departing from the essential characteristics of the present invention.

Therefore, the embodiments disclosed in the present disclosure are intended to illustrate rather than limit the technical idea of the present invention, and the scope of the technical idea of the present invention is not limited by these embodiments.

The scope of protection of the present invention should be construed according to the following claims, and all technical ideas falling within the equivalent scope to the scope of protection should be construed as falling within the scope of the present invention.

What is claimed is:

1. A robot system comprising a left exercise module and a right exercise module, which are horizontally spaced apart from each other and each of which comprises:
a lifting guide;
a carrier lifted/lowered and guided along the lifting guide; and
a robot arm installed on the carrier, comprising an end effector connected to an arm, and having a height changed by the carrier.

2. The robot system of claim 1, wherein a maximum length of the robot arm is shorter than a length of the lifting guide.

3. The robot system of claim 1, wherein the maximum length of the robot arm is shorter than a distance between the lifting guide of the left exercise module and the lifting guide of the right exercise module.

4. The robot system of claim 1, further comprising a controller configured to controlling the robot arm, wherein
the controller controls the robot arm in a plurality of modes, the plurality of modes comprises
a waiting mode in which the robot arm is moved to a waiting position, and
an exercise mode in which the robot arm is moved to an exercise region where the robot arm is operable by a user, and wherein
a first distance between the robot arm of the left exercise module and the robot arm of the right exercise module in the waiting mode is larger than a second distance between the robot arm of the left exercise module and the robot arm of the right exercise module in the exercise mode.

5. The robot system of claim 1, further comprising lifting mechanisms configured to raise/lower the carriers.

6. The robot system of claim 5, wherein the lifting mechanisms lifts/lowers the carrier of the left exercise module and the carrier of the right exercise module to the same height.

7. The robot system of claim 1, wherein each of the left exercise module and the right exercise module further comprises a carrier locker configured to fix the carrier.

8. The robot system of claim 1, comprising an input part for a user input, wherein the input part is arranged on the carrier.

9. The robot system of claim 1, comprising a speaker configured to provide a voice guide to a user, wherein the speaker is arranged on the carrier.

10. The robot system of claim 1, further comprising: torque sensors configured to sense torque of the arm and angles of the arm.

11. The robot system of claim 1, wherein the robot arm each further comprise an end effector sensor installed on the end effector.

12. The robot system of claim 11, wherein the end effector sensor further comprises a touch sensor configured to sense a touch of a user.

13. The robot system of claim 11, wherein the end effector sensor further comprises a force sensor configured to sense a force applied to the end effector.

14. A method for controlling a robot system, which comprises
carriers in which a left exercise module and a right exercise module each lifted/lowered and guided along a lifting guide, and
robot arms each having a height changed by the carrier, the method for controlling a robot system comprising:
capturing a body of a user by a vision sensor when user information is input by the user;
storing user data according to the body of the user in a memory;
moving an end effector of the robot arm to an exercise region when the user is located at the exercise region after calculating an exercise motion determined by the user data and exercise information if desired exercise information is input by the user; and
performing the exercise motion by robot arms if the user holds the end effectors.

15. The method for controlling a robot system of claim 14, wherein in moving an end effector, whether the user is located at the exercise region is determined by an image captured by the vision sensor.

16. The method for controlling a robot system of claim 14, further comprising inquiring a suitability of the present exercise motion to the user via an output unit.

17. The method for controlling a robot system of claim 16, wherein
after inquiring a suitability of the present exercise motion, storing in a memory whether the exercise motion succeeds for each user is performed if the user inputs satisfaction via the input unit, and
generating a new exercise motion if the user inputs dissatisfaction via the input unit.

18. A method for controlling a robot system, which comprises
carriers in which a left exercise module and a right exercise module which are horizontally spaced apart from each other, and each of which is lifted/lower and guided along a lifting guide, and
robot arms each having a height changed by the carrier, the method for controlling a robot system comprising:
displaying an exercise motion corresponding to exercise information on an output unit if a user inputs the exercise information;
moving an end effectors of the robot arms to an exercise region if the user inputs agreement to a displayed exercise motion; and
controlling the robot arm configured to perform the exercise motion determined according to the input exercise information if the user holds the end effectors.

19. The method for controlling a robot system of claim 18, wherein
the exercise information input by the user comprises exercise strength, and
in moving an end effectors of the robot arms, a torque corresponding to the exercise strength is applied to the end effectors.

20. The method for controlling a robot system of claim 19, displaying the exercise motion is performed if the exercise information is input by the user after recognizing the user, and when the exercise motion corresponding to an exercise degree of exercise input by the user is stored.
